(19) United States
(12) Patent Application Publication
(10) Pub. No.: US 2021/0016436 A1
(43) Pub. Date: Jan. 21, 2021

(54) GRIPPING AND MOBILIZING SYSTEM

(71) Applicant: IDEA MACHINE DEVELOPMENT DESIGN AND PRODUCTION LTD., Rehovot (IL)

(72) Inventors: Shlomo TURGEMAN, Rishon Letzion (IL); Eitan SHEFFER, Ramat Gan (IL); Ben Zion LAVI, Rehovot (IL)

(21) Appl. No.: 17/042,769

(22) PCT Filed: Mar. 26, 2019
(86) PCT No.: PCT/IB2019/052463

§ 371 Date: Sep. 28, 2020

Related U.S. Application Data
(60) Provisional application No. 62/648,922, filed on Mar. 27, 2018.

(51) Int. Cl. B25J 9/14; B25J 9/10; B25J 18/04; B25J 15/00

(52) U.S. Cl. CPC B25J 9/144; B25J 15/0014; B25J 18/04; B25J 9/109

(57) ABSTRACT

A gripping system including a pneumatic arm assembly, which includes an anchoring bracket, first and second pairs of arms pivotably attached to opposing sides of the anchoring bracket, and a connector bracket, pivotably attached to the first and second pairs of arms. Motion of the connector bracket results from motion of the first and second pairs of arms. A gripping assembly is mounted onto the connector bracket, and includes a pair of gripping arms adapted to grip an object. A pneumatic control assembly includes a pneumatic piston which drives motion of the first and second pairs of arms, the connector bracket, and the gripping arms. During the motion of the connector bracket and the gripping arms, an angle of the connector bracket and of the gripping arms relative to the x-y plane remains relatively constant.

### RELATED APPLICATIONS

This application claims priority from, and the benefit of, U.S. provisional application No. 62648922, filed Mar. 27, 2018, the contents of which are incorporated herein by reference.

### BACKGROUND

Plates containing a multiplicity of wells for holding samples of chemicals, cells or other biological materials for observation, are known in the art. Commonly, such plates have a 3:2 aspect ratio and thus contain 24 (4×6), 96 (8×12), 384 (16×24), or 1536 (32×48) wells; a typical 96-well plate is 128 mm long and 86 mm wide, and standards for the footprint and bottom outside flange of 96-well plates are described in ANSI/SBS 1-2004 and ANSI/SBS 3-2004, respectively.

Such multi-well plates, also sometimes referred to as microwell plates or microtiter plates depending on the volume of the wells, are generally constructed of plastic, e.g. polystyrene, polypropylene or polycarbonate, or a combination of such materials, in some cases also incorporating glass in the bottom portion of the plate. In many applications, the bottom of the well is transparent to a frequency of light that will be used to observe the sample. The size of wells in terms of depth, height, and total volume, as well the shape of the wells and the shape of the bottoms of the wells, varies in accordance with the particular use to which the plate is to be put.

Examples of commercial suppliers of such plates are:

Perkin-Elmer (see http://www.perkinelmer.com/CMSResources/Images/44-73879SPC_MicroplateDimensionsSummaryChart.pdf);

Sigma-Aldrich (see http://www.sigmaaldrich.com/labware/labware-products.html?TablePage=9576216); and

Thermo-Scientific (see http://www.thermoscientific.com/ecomm/servlet/productscatalog_11152_81996_-1_4).

One area in which widespread use of such plates is made is high-throughput screening for the testing of compounds in drug development, binding assays for antigens and the like.

Often, in high-throughput screening and other applications, automated machinery is used to move multiwell plates from one location to another, such as from a storage incubator to a microscope system for viewing the content of the wells or vice versa. However, because of the sensitivity of biological materials tested in microwell plates, it is desirable to minimize the disturbance of the contents of such plates. Maintaining such plates level while they are moved is generally a minimal goal, to avoid spillage of the contents.

### SUMMARY

There is provided in accordance with an embodiment of the invention a gripping system including:

a pneumatic arm assembly including:
an anchoring bracket;
a first pair of arms pivotably attached to opposing sides of the anchoring bracket at a pair of respective first positions, each arm in the first pair of arms being adapted to move in a corresponding plane generally perpendicular to an x-y plane;
a second pair of arms pivotably attached to the opposing sides of the anchoring bracket at a pair of respective second positions, each arm in the second pair of arms being adapted to move in a corresponding plane;
wherein each second position is disposed at a diagonal to a corresponding first position, along each of the opposing sides of the anchoring bracket;
a cam subassembly connected to the first pair of arms; and
a connector bracket, pivotably attached to the first and second pairs of arms, and motion of the connector bracket results from motion of the first and second pairs of arms;

a gripping assembly, mounted onto the connector bracket, the gripping assembly including a pair of gripping arms adapted to grip an object; and

a pneumatic control assembly, including a pneumatic piston functionally associated with the cam subassembly, configured so that pneumatic changes in the pneumatic piston are applied, via the cam subassembly, to the first pair of arms, so as to drive motion of the first pair of arms, the second pair of arms, the connector bracket, and the gripping arms,

wherein during the motion of the connector bracket and the gripping arms, an angle of the connector bracket and of the gripping arms relative to the x-y plane remains constant within a threshold of 0.2 degrees.

In some embodiments, the connector bracket includes an upper wall, a back wall generally perpendicular to the upper wall, and two side walls extending from opposing sides of the back wall, the side walls being generally perpendicular to the upper wall and to the back wall.

In some such embodiments, an arm of the first pair of arms is pivotably attached to each of the side walls at a first bracket position, an arm of the second pair of arms is pivotably attached to each of the side walls at a second bracket position, wherein each the second bracket position is disposed at a diagonal to a corresponding first bracket position, along each of the side walls of the connector bracket.

In some embodiments, the gripping assembly is mounted onto a lower surface of the upper wall of the connector bracket.

In some embodiments, the gripping assembly includes a second pneumatic assembly, functionally associated with the gripping arms and adapted to move the gripping arms towards and away from each other, to facilitate gripping and releasing of an object.

In some embodiments, a first length of the arms in the first pair of arms is in the range of 4 cm to 10 cm, such as 4 cm to 8 cm or 4 cm to 6 cm, e.g. 4 cm, 4.5 cm, 5 cm, 5.5 cm, 6 cm, 6.5, 7 cm, 7.5 cm, 8 cm, 8.5 cm, 9 cm, 9.5 cm or 10 cm. In some embodiments, a second length of the arms in the second pair of arms is in the range of 4 cm to 10 cm, such as 4 cm to 8 cm 9.5 cm or 10 cm.

In some embodiments, a difference between a first length of the arms in the first pair of arms and a second length of arms in the second pair of arms is at most 0.05 mm.

In some embodiments, pivotal motion of the first and the second pairs of arms relative to the anchoring bracket is limited at a first end by a surface of the anchoring bracket.

In some embodiments, pivotal motion of the first and the second pairs of arms relative to the anchoring bracket is limited by a range of motion of a pneumatic plunger forming part of the pneumatic piston.

In some embodiments, each of the arms in the first pair of arms and in the second pair of arms includes a first end, pivotably attached to the anchoring bracket, and a second end, distal to the first end, pivotably attached to the connector bracket.

In some embodiments, when the first pair of arms pivot relative to the anchoring bracket from a first orientation to a second orientation utilizing the full range of motion of arms in the first pair of arms, a vertical difference between the second end of each of the arms in the first orientation and the second end of each of the arms in the second orientation is in the range of 20 mm to 50 mm, e.g. with the range of 30 mm to 40 mm, for example 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm or 50 mm.

In some embodiments, when the first pair of arms pivot relative to the anchoring bracket from a first orientation to a second orientation utilizing the full range of motion of arms in the first pair of arms, a vertical difference between a location of gripping ends of the gripping arms when the first pair of arms are in the first orientation and a location of the gripping ends of the gripping arms when the first pair of arms are in the second orientation is in the range of 20 mm to 50 mm, e.g. with the range of 30 mm to 40 mm, for example 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm or 50 mm.

In some embodiments, the gripping system further includes an object gripped by the gripping arms. In some embodiments, during motion of the gripping arms, an angular orientation of the object relative to the x-y plane remains constant within a threshold of 0.2 degrees.

In some embodiments, the gripping system further includes a mobilizing system functionally associated with the pneumatic arm assembly, the mobilizing system adapted to at least one of (a) move the pneumatic arm assembly, so as to change a location of the first and the second pairs of arms within the x-y plane and (b) pivot the pneumatic arm assembly about the z-axis, so as to change an orientation of the first and the second pairs of arms within the x-y plane.

In some embodiments, the object is a multiwell plate disposed between the gripping arms and gripped thereby.

There is further provided, in accordance with an embodiment of the present invention, a method for raising or lowering an object, the method including:

while the object is located at an origin height, gripping the object with the gripping arms of the gripping system described herein; and

pivoting the first and second pairs of arms relative to the anchoring bracket, causing vertical movement of the gripping arms and the object gripped therebetween to a destination height,

wherein, during the pivoting of the first and second pairs of arms, an angular orientation between the object and an x-y plane remains constant within a threshold of 0.2 degrees.

In some embodiments, the gripping system further includes a mobilizing system functionally associated with the pneumatic arm assembly of the gripping system, the mobilizing system adapted to at least one of (a) move the pneumatic arm assembly so as to change a location of the first and the second pairs of arms within the x-y plane and (b) pivot the pneumatic arm assembly about the z-axis so as to change an orientation of the first and the second pairs of arms within the x-y plane,

the method further including moving the gripping system using the mobilizing system, while maintaining the object level.

In some embodiments, the object includes a multiwell plate.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, an object is considered to be “kept level” during motion of the object (a) if during such motion the angle of the object, relative to the horizontal, does not vary by more than 0.2 degrees, e.g. not more than 0.1 degrees or (b) if the tilt of a base surface of the object during the motion, relative to the initial position of the base surface, is at most 0.2 mm, e.g. at most 0.1 mm.

As used herein, the term x-y plane refers to a base plane, which is typically generally horizontal, such as the surface of a table, the floor, and the like. A base surface to which a device in accordance with the presently claimed invention is anchored will generally define such a base plane.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1A is perspective illustration of a gripping and mobilizing system in accordance with an embodiment of the teachings herein;

FIG. 1B is a partially cut-away perspective illustration of the gripping and mobilizing system of FIG. 1A;

FIGS. 2A and 2B are, respectively, planar side view illustrations of the gripping and mobilizing system of FIGS. 1A and 1B, in two operative positions;

FIG. 3 is a sectional view illustration of the gripping and mobilizing system of FIGS. 1A and 1B, the sectional illustration taken along section lines III-III in FIG. 1A; and

FIGS. 4A and 4B are, respectively, an exploded view illustration and a perspective view illustration of a pneumatic arm subsystem forming part of the system of FIGS. 1A to 3.

### DESCRIPTION OF SOME EMBODIMENTS OF THE INVENTION

There is provided a gripping and mobilizing system, for moving an object, such as a multi-well plate, while keeping it level and providing substantially smooth movement. As a result, disturbance of the contents of the plate can be minimized. The system can move the multi-well plate along a vertical (Z) axis, and can be mounted on a suitable platform to enable motion from one location to another along the X and Y axes.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

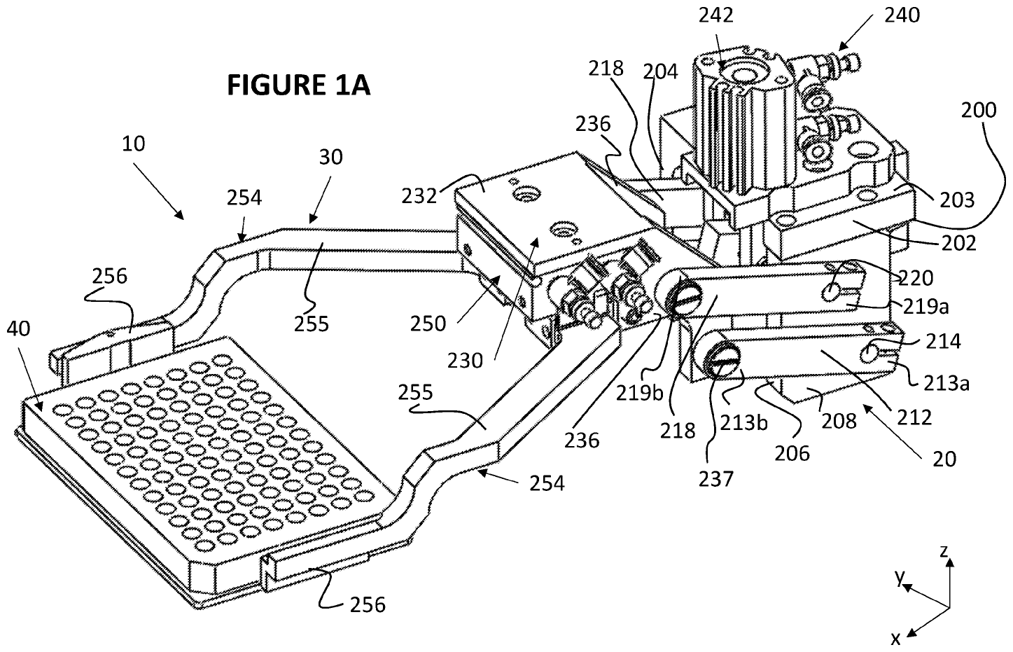

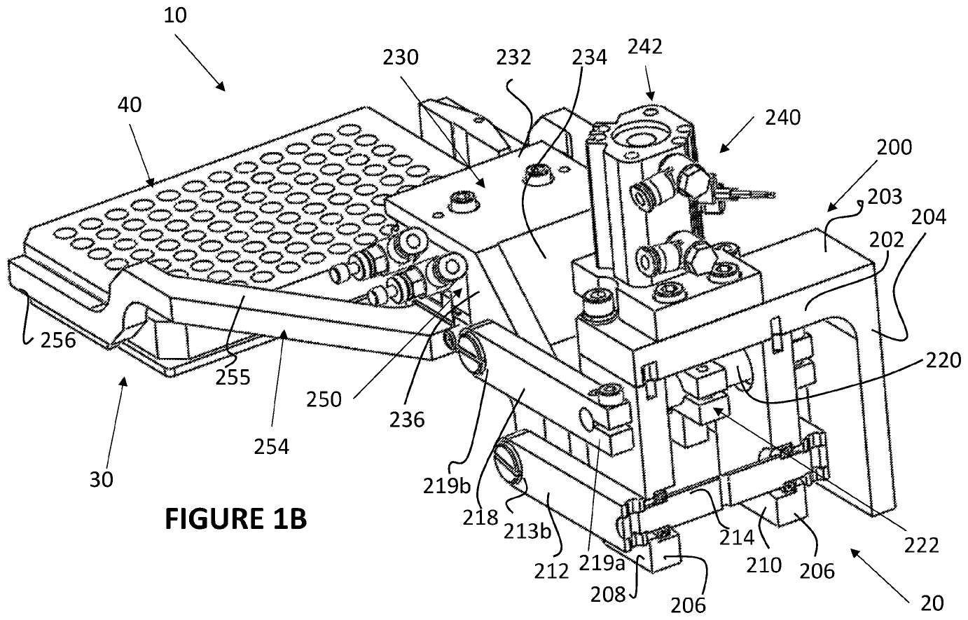

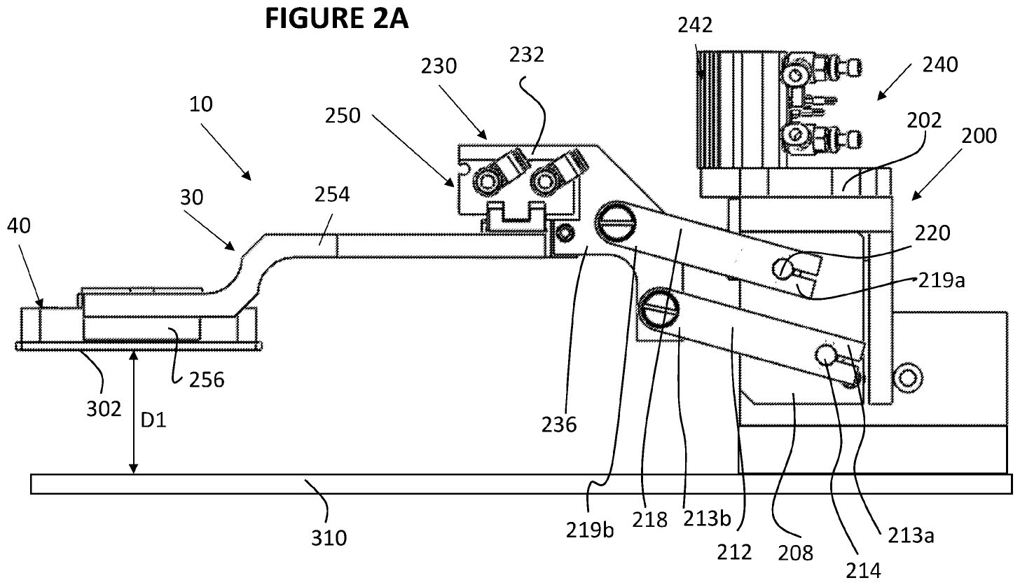

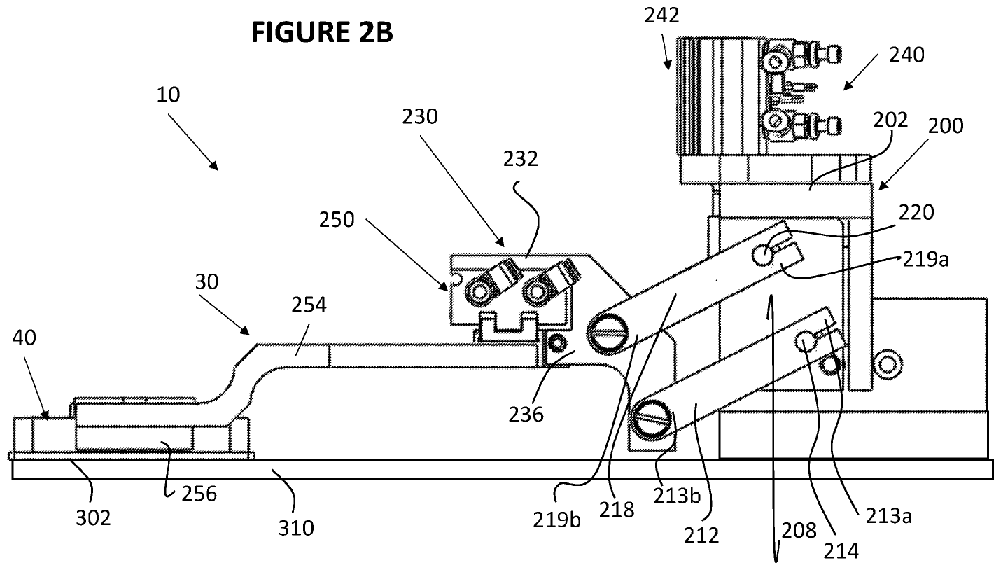

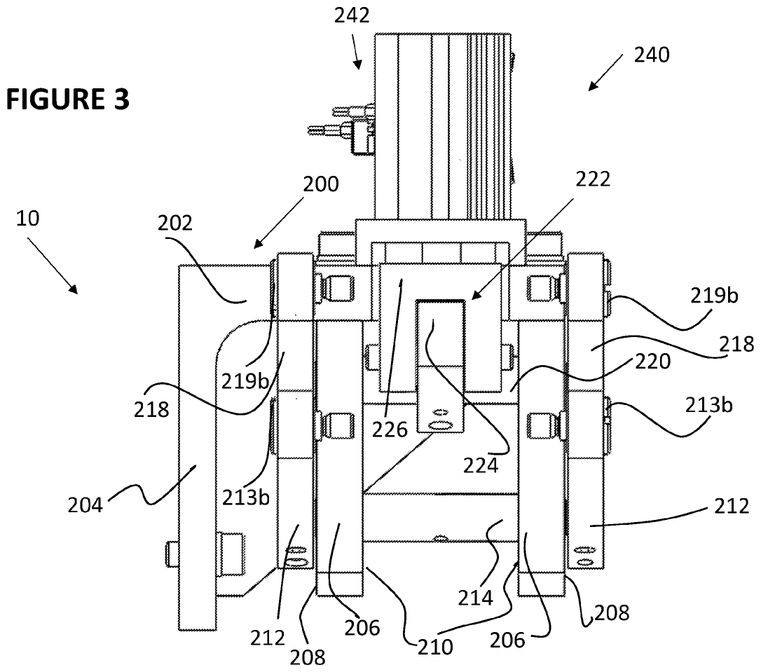

Reference is now made to FIG. 1A, which is a perspective illustration of a gripping and mobilizing system 10 in accordance with an embodiment of the teachings herein, to FIG. 1B, which is a partially cut-away perspective illustration of the gripping and mobilizing system 10, to FIGS. 2A and 2B, which are, respectively, planar side view illustrations of the gripping and mobilizing system 10 in two operative positions, and to FIG. 3, which is a sectional illustration of the gripping and mobilizing system 10.

As seen, gripping and mobilizing system 10 includes a pneumatic arm subassembly 20, which is connected to and controls motion of a gripping subassembly 30, adapted to grip and move a multi-well plate 40.

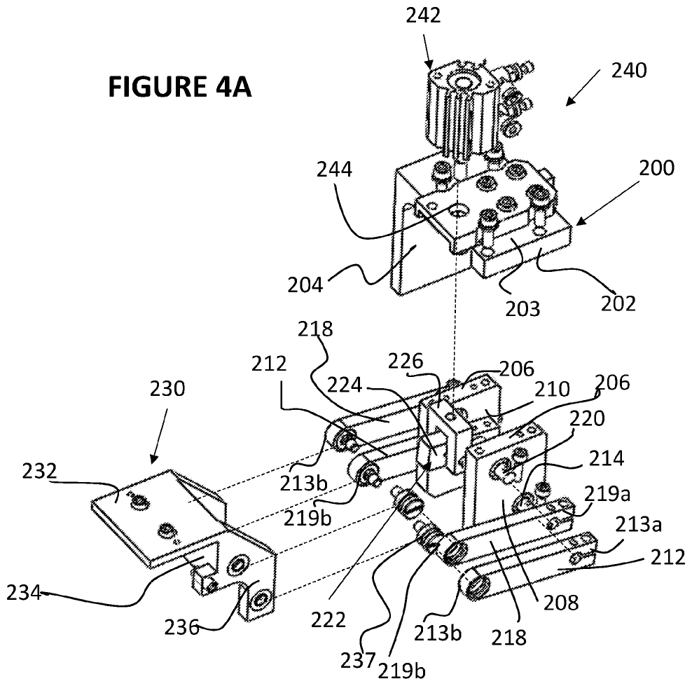

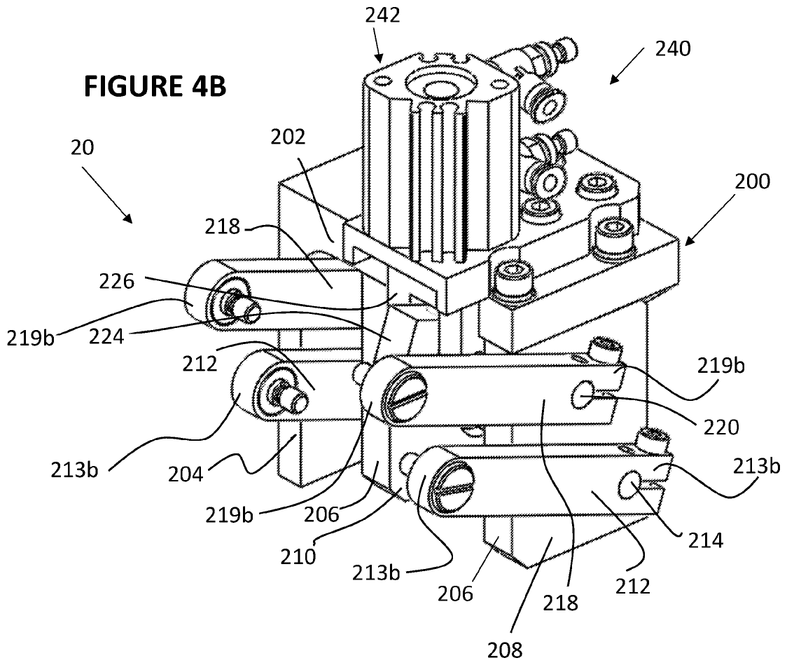

Pneumatic arm subassembly 20 is described with additional reference to FIGS. 4A and 4B, which are, respectively, an exploded view illustration and a perspective view illustration of pneumatic arm subsystem 20.

Pneumatic arm subassembly 20 includes an L-shaped anchoring bracket 200, including a substantially horizontal portion 202 having an upper surface 203, and a substantially vertical leg 204. L-shaped anchoring bracket 200 is adapted to be anchored to a base platform (not explicitly shown). Extending downward from substantially horizontal portion 202, substantially parallel to leg 204, are a pair of substantially vertical supports 206, which may also be anchored to the base platform. Each of supports 206 includes an exterior facing surface 208 and an interior facing surface 210, shown also in FIG. 4A.

A first pair of arms 212 is rotatably attached to each of exterior facing surfaces 208 of supports 206, at a first position. First ends 213a of arms 212 are connected to opposing ends of, and are adapted to be rotated by, an axle 214 extending through vertical supports 206. A second pair of arms 218 is rotatably attached to each of exterior facing surfaces 208 of supports 206, at a second position. First ends 219a of arms 218 are connected to opposing ends of, and are adapted to be rotated by, an axle 220 extending through vertical supports 206. Arms 212 and 218 are pivotable relative to the axes of axles 214 and 220, respectively. As explained in further detail hereinbelow, the lengths of arms 212 and 218 are substantially identical. Arms 212 and 218 are configured to move within planes which are generally perpendicular to an x-y plane, such as the base surface of the system.

A cam subassembly 222 includes a bar 224 and a rectangular frame portion 226 which is open at a bottom side thereof. Bar 224 is fixedly attached to axle 220, and frame portion 226 is mounted onto an end of bar 224, distal to axle 220. A bore 228 is formed in an upper side of rectangular frame portion 226, for connection to a pneumatic control subassembly, as described hereinbelow.

A connector bracket 230 includes a horizontal planar portion 232, a rear wall 234 perpendicular to horizontal planar portion 232, and a pair of side legs 236 perpendicular to both the horizontal wall 232 and the rear wall 234. Second ends 213b of arms 212 and second ends 219b of arms 218 are connected to side legs 236 of the connector bracket by connectors 240, such that rotational motion of one of the pairs of arms, either 212 or 218, results in corresponding motion of the other pair of arms, viz. 218 or 212, and of connector bracket 230.

Arms 212 and 218 have the same length, but are not fully parallel to one another. Stated differently, the first position at which arms 212 are connected to supports 206 and the second position at which arms 218 are connected to supports 206 are at different vertical heights and at different horizontal locations (locations along the X-axis) such that the first and second positions are diagonal to one another. Similarly, a first position at which arms 212 are connected to side legs 236 and the second position at which arms 218 are connected to side legs 236 are at different vertical heights and at different horizontal locations (locations along the X-axis of the connector bracket) such that the first and second positions are diagonal to one another.

It will be noted that, when connected to arms 212 and 218, connector bracket 230 has no degrees of freedom relative to arms 212 and 218, and cannot rotate, tip, or tilt relative to either of the axes along which it is connected to arms 212 and 218. As such, horizontal planar portion 232 of connector bracket 230 is parallel to horizontal portion 202 at all times, and rotational motion of arms 212 and 218 about respective axes of axles 214 and 220 is translated at least in part to vertical motion of connector bracket 230, i.e. a motion component along the z-axis, while the orientation of the connector bracket 230 relative to the X-Y plane or to a base surface parallel thereto, such as the floor, does not change.

In some embodiments, such as the illustrated embodiment, the arms 212 and 218 are connected to connector bracket 230 by shoulder pins 237, which are fixed relative to connector bracket 230 and are pivotable relative to arms 212 and 218. In some such embodiments, bearings are disposed about at least a portion of shoulder pins 237, to support such pivoting between the pins 237 and the arms 212 and 218. However, it will be appreciated that other forms of connection are within the scope of the present invention and will be appreciated by those skilled in the art.

A pneumatic control subassembly 240 is mounted onto upper surface 203 of anchoring bracket 200. A pneumatic piston 242 of subassembly 240, extends through a bore 244 in horizontal portion 202 of anchoring bracket 200, and through the upper side of rectangular frame portion 226 of cam assembly 222, for pneumatic control of axle 220 to drive rotational motion of arm pairs 212 and 218 as explained herein.

Mounted onto a bottom side of horizontal planar portion 232 of connector bracket 230 is the gripping subassembly 30. Specifically, the gripping subassembly includes a second pneumatic control assembly 250, which is mounted onto planar portion 232. Extending from either side of second pneumatic control assembly 250 is a gripping arm 254, which includes a generally planar horizontal region 255 and terminates in a flat gripping end 256. Gripping ends 256 are substantially parallel to one another, and are generally perpendicular to a base surface, such as the floor. Second pneumatic control assembly 250 is adapted to move gripping arms 254 such that the distance between the arms changes, without changing the rotational orientation of the arms, such that horizontal regions 255 remain substantially parallel to the base surface, or to the floor, and the gripping ends 256 remain parallel to each other and perpendicular to the floor, throughout the motion of the gripping arms 254. The gripping arms may be used to grip any object, such as a multi-well plate 300 illustrated in FIGS. 1A to 2B.

In use, pneumatic control subassembly 240 pneumatically causes motion of pneumatic transmission subassembly 222. Specifically, pneumatic piston 242, which is attached to frame portion 226, drives pneumatic motion of frame portion 226 which results in corresponding pneumatic motion of bar 224 and of axle 220 fixedly attached thereto. As explained above, due to arms 212 and 218 being fixedly connected to side legs 236 of connector bracket 230, motion of axle 220 results in corresponding motion of arms 218, connector bracket 230, and arms 212. Due to the fixed connection between connector bracket 230 and the gripping subassembly 30, motion of the arms 212 and 218 results in raising and lowering of the gripping arms 254. However, because the connector bracket 230 has no degrees of freedom relative to arms 212 and 218, and always moves together with the arms and remains horizontal, and because the gripping arms do not have vertical or rotational degrees of freedom relative to the connector bracket 230, any motion of arms 212 and 218 results in motion of the gripping arms 254, without changing the direction of the gripping ends 256 relative to the horizontal. Consequently, any object gripped by gripping ends 256 retains its three-dimensional orientation relative to the x-y plane during motion, e.g. the object remains parallel to the horizontal, and does not tilt or shift, during motion of arms 212 and 218 and corresponding motion of arms 256.

The range of motion of arms 212 and 218 is mechanically limited. Specifically, downward motion is limited by the characteristics of the pneumatic piston 242, and specifically by the length of the plunger (not shown) of the pneumatic piston 242. Upward motion is limited by engagement of arm 218 with horizontal top portion 202 of anchoring bracket 200, as seen clearly in FIG. 1A. As such, the angular range of motion of the arms is dependent on the length of the pneumatic piston, wherein a longer piston allows for a greater angular range of motion. However, the radius of arc of motion of arms 212 and 218, and the length of such arc, are dependent on the length of arms 212 and 218.

It will be appreciated that, when an object is held in gripping arms 254 in a specific orientation, the object remains level with respect to that specific orientation, throughout the motion of arms 254. In order to maintain an angular arrangement of the object within a range of 0-0.2 degrees from the specific orientation, during motion of gripping arms 254, the lengths of arms 212 and 218 must be equal, or within a threshold of 0-0.05 mm, e.g. within of 0-0.02 mm, from equal.

The smoothness of motion of arms 212 and 218, and consequently the smoothness of vertical motion of gripping arms 254, is dependent on characteristics of the pneumatic piston 242, such that the smoother the motion of the pneumatic piston, the smoother the motion of the arms 212, 218, and 254.

In the illustrated embodiment shown in FIGS. 2A and 2B, gripping arms 254 hold multiwell plate 300, such that a lower surface 302 of the multiwell plate is substantially parallel to a base surface 310, such as a table or a floor. In the position shown in FIG. 2A, arms 212 and 218 are angled upward away from the base surface 310, such that plate 300 is raised above base surface 310 to a first distance D1. In the position shown in FIG. 2B, arms 212 and 218 are angled toward the base surface 310, such that plate 300 is placed directly on base surface 310. As such, downward motion of arms 212 and 218 (between the position shown in FIG. 2A and the position shown in FIG. 2B) results in corresponding downward motion of plate 300, while constantly maintaining lower surface 302 of the plate substantially parallel to the base surface.

In some embodiments, for example in embodiments in which the object to be moved is a multi-well plate as illustrated in FIGS. 1A to 2B, the lengths of arms 212 and 218 are in the range of 4 cm to 10 cm, such as 4 cm to 8 cm or 4 cm to 6 cm, e.g. 4 cm, 4.5 cm, 5 cm, 5.5 cm, 6 cm, 6.5, 7 cm, 7.5 cm, 8 cm, 8.5 cm, 9 cm, 9.5 cm or 10 cm. In some such embodiments, the vertical difference D1 between the height of the plate when held at the lowest position of the arms, for example as shown in FIG. 2B, and the height of the plate when held at the highest position of the arms, for example as shown in FIG. 2A is in the range of 20 mm to 50 mm, e.g. with the range of 30 mm to 40 mm, for example 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm or 50 mm.

In some embodiments, the gripping and mobilizing system 10 may be mounted onto a mobilizing assembly (not explicitly shown) capable of moving the gripping and mobilizing system 10 along the X, Y, and Z axes, and/or capable or pivoting the gripping and mobilizing system 10 such that gripping arms 254 may point to different directions at different times. Such a mobilizing assembly would facilitate use of the gripping and mobilizing system 10 for lifting an object from a first location, moving the object to a second location, and placing the object at the second location, while keeping the object level, and/or maintaining the three-dimensional orientation of the object, relative to the x-y plane throughout the motion of the object. For example, the gripping and mobilizing system 10 may lift multiwell plate 40 from a storage incubator, move multiwell plate 40 to a microscope system by motion of the mobilizing assembly, and place multiwell plate 40 on the microscope system, while maintaining the base surface of the multwell plate level during motion thereof. As a result, the disruption of the content of the multiwell plate 40 by the motion of the plate may be minimized.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A gripping system comprising:
a pneumatic arm assembly including:
an anchoring bracket;
a first pair of arms pivotably attached to opposing sides of said anchoring bracket at a pair of respective first positions, each arm in said first pair of arms being adapted to move in a corresponding plane generally perpendicular to an x-y plane;
a second pair of arms pivotably attached to said opposing sides of said anchoring bracket at a pair of respective second positions, each arm in said second pair of arms being adapted to move in a said corresponding plane;
wherein each said second position is disposed at a diagonal to a corresponding said first position, along each of said opposing sides of said anchoring bracket;
a cam subassembly connected to said first pair of arms; and
a connector bracket, pivotably attached to said first and second pairs of arms, and motion of said connector bracket results from motion of said first and second pairs of arms;
a gripping assembly, mounted onto said connector bracket, said gripping assembly including a pair of gripping arms adapted to grip an object; and
a pneumatic control assembly, including a pneumatic piston functionally associated with said cam subassembly, configured so that pneumatic changes in said pneumatic piston are applied, via said cam subassembly, to said first pair of arms, so as to drive motion of said first pair of arms, said second pair of arms, said connector bracket, and said gripping arms,
wherein during said motion of said connector bracket and said gripping arms, an angle of said connector bracket and of said gripping arms relative to said x-y plane remains constant within a threshold of 0.2 degrees.

2. The gripping system of claim 1, wherein said connector bracket includes an upper wall, a back wall perpendicular to said upper wall, and two side walls extending from opposing sides of said back wall, said side walls being perpendicular to said upper wall and to said back wall.

3. The gripping system of claim 2, wherein an arm of said first pair of arms is pivotably attached to each of said side walls at a first bracket position, an arm of said second pair of arms is pivotably attached to each of said side walls at a second bracket position, wherein each said second bracket position is disposed at a diagonal to a corresponding said first bracket position, along each of said side walls of said connector bracket.

4. The gripping system of claim 2 or claim 3, wherein said gripping assembly is mounted onto a lower surface of said upper wall of said connector bracket.

5. The gripping system of any one of claims 1 to 4, wherein said gripping assembly includes a second pneumatic assembly, functionally associated with said gripping arms and adapted to move said gripping arms towards and away from each other, to facilitate gripping and releasing of an object.

6. The gripping system of any one of claims 1 to 5, wherein a first length of said arms in said first pair of arms is in the range of 4 cm to 10 cm.

7. The gripping system of any one of claims 1 to 6, wherein a second length of said arms in said second pair of arms is in the range of 4 cm to 10 cm.

8. The gripping system of any one of claims 1 to 7, wherein a difference between a first length of said arms in said first pair of arms and a second length of arms in said second pair of arms is at most 0.05 mm.

9. The gripping system of any one of claims 1 to 8, wherein pivotal motion of said first and said second pairs of arms relative to said anchoring bracket is limited at a first end by a surface of said anchoring bracket.

10. The gripping system of any one of claims 1 to 9, wherein pivotal motion of said first and said second pairs of arms relative to said anchoring bracket is limited by a range of motion of a pneumatic plunger forming part of said pneumatic piston.

11. The gripping system of any one of claims 1 to 10, wherein each of said arms in said first pair of arms and in said second pair of arms includes a first end, pivotably attached to said anchoring bracket, and a second end, distal to said first end, pivotably attached to said connector bracket.

12. The gripping system of claim 11, wherein when said first pair of arms pivot relative to said anchoring bracket from a first orientation to a second orientation utilizing the full range of motion of arms in said first pair of arms, a vertical difference between said second end of each of said arms in said first orientation and said second end of each of said arms in said second orientation is in the range of 20 mm to 50 mm.

13. The gripping system of any one of claims 1 to 12, wherein when said first pair of arms pivot relative to said anchoring bracket from a first orientation to a second orientation utilizing the full range of motion of arms in said first pair of arms, a vertical difference between a location of gripping ends of said gripping arms when said first pair of arms are in said first orientation and a location of said gripping ends of said gripping arms when said first pair of arms are in said second orientation is in the range of 20 mm to 50 mm.

14. The gripping system of any one of claims 1 to 13, further comprising an object gripped by said gripping arms.

15. The gripping system of claim 14, wherein during motion of said gripping arms, an angular orientation of said object gripped by said gripping arms relative to said x-y plane remains constant within a threshold of 0.2 degrees.

16. The gripping system of any one of claims 1 to 15, further comprising a mobilizing system functionally associated with said pneumatic arm assembly, said mobilizing system adapted to at least one of (a) move said pneumatic arm assembly, so as to change a location of said first and said second pairs of arms within said x-y plane and (b) pivot said pneumatic arm assembly about the z-axis, so as to change an orientation of said first and said second pairs of arms within said x-y plane.

17. The gripping system of claim 15 or claim 16, wherein said object is a multiwell plate disposed between said gripping arms and gripped thereby.

18. A method for raising or lowering an object, the method comprising:
while said object is located at an origin height, gripping said object with the gripping arms of the gripping system of any one of claims 1 to 16; and
pivoting said first and second pairs of arms relative to said anchoring bracket, causing vertical movement of said gripping arms and said object gripped therebetween to a destination height,
wherein, during said pivoting of said first and second pairs of arms, an angular orientation between said object and an x-y plane remains constant within a threshold of 0.2 degrees.

19. The method of claim 18, wherein said gripping system further comprises a mobilizing system functionally associated with the pneumatic arm assembly of said gripping system, said mobilizing system adapted to at least one of (a) move said pneumatic arm assembly so as to change a location of said first and said second pairs of arms within said x-y plane and (b) pivot said pneumatic arm assembly about the z-axis so as to change an orientation of said first and said second pairs of arms within said x-y plane,
said method further comprising moving said gripping system using said mobilizing system, while maintaining said object level.

20. The method of claim 18 or claim 19, wherein said object comprises a multiwell plate.
